(19) United States
(12) Patent Application Publication
(10) Pub. No.: US 2016/0028798 A1
(43) Pub. Date: Jan. 28, 2016

(54) Peer Network Membership Management

(71) Applicant: Google Technology Holdings LLC, Mountain View, CA (US)

(72) Inventors: Jagadish Kumar Agrawal, Santa Clara, CA (US); Sujoy Das, Grayslake, IL (US); Nathan J Fortin, Morgan Hill, CA (US); Jordan Andrew Hurwich, Palo Alto, CA (US); Catherine T Nguyen, Mountain View, CA (US); Akila Varadarajan, San Jose, CA (US)

(21) Appl. No.: 14/338,629

(22) Filed: Jul. 23, 2014

(51) Int. Cl. H04L 29/08; G06F 17/30; H04L 29/06

(52) U.S. Cl. CPC H04L 67/104; H04L 65/403; G06F 17/30876

(57) ABSTRACT

Techniques are described that may be utilized to manage membership of peers in a peer-to-peer network. For example, membership may be based at least in part on a score that is calculated that describes a reputation for peers in the peer-to-peer network. The calculation of the score may be based, at least in part, on a number of peers that provided reports of inappropriate content, rather than relying solely on a number of reports received from the peers as was performed using conventional techniques. In another example, this score may also be calculated, at least in part, to reflect a positive score for the peer. For instance, the score may also be adjusted based on a number of peers that also received the content but did not report the content as inappropriate.

### BACKGROUND

Peer-to-peer networks are typically formed as a collection of peers that are connected to each other via a distributed network architecture to share and consume content. Peer-to-peer networks may be configured in a variety of different ways to share a variety of different content. For example, the networks may be configured to act as a file-sharing network, support streaming media, share computational resources, and so forth.

In some instances, content shared by peers in the peer-to-peer network may be considered inappropriate by other peers in the network. Accordingly, techniques have been developed to manage membership of peers within the network, such as to revoke membership of a peer that shares this inappropriate content. However, conventional membership management techniques that are employed to manage membership of the peers in the peer-to-peer network could result in a minority of the peers and even a single peer in the network having the power to remove other peers in the network, and thus could be result in abuse by a the minority of the peers.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the peer-to-peer membership management techniques described herein.

FIG. 2 depicts a system in an example implementation in which a number of peers that report content as inappropriate is utilized to calculate a score to manage membership of a peer in a peer-to-peer network.

FIG. 3 depicts a system in an example implementation in which a score is calculated to manage membership of a peer in a peer-to-peer network.

FIG. 4 is a flow diagram depicting a procedure in an example implementation in which peer-to-peer content sharing and scoring behaviors are described.

FIG. 5 depicts a system in an example implementation in which reports of content as inappropriate is utilized along with a lack of such reports to calculate a score to manage membership of a peer in a peer-to-peer network.

FIG. 6 is a flow diagram depicting a procedure in an example implementation in which scoring behaviors that include use of likely positive indications are described.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

Membership of peers in a peer-to-peer network may be managed, which may include remove of members that send inappropriate content to other peers in the network. However, these techniques, conventionally, could enable even a single user to make repeated reports that could result in blacklisting a peer, even if other members of the peer-to-peer network did not deem this removal warranted.

Accordingly, techniques are described herein that may be utilized to manage membership of peers in a peer-to-peer network, which may be performed in a variety of ways. For example, membership may be based on a score that is calculated that describes a reputation for peers in the peer-to-peer network. The calculation of the score may be based, at least in part, on a number of peers that provided reports of inappropriate content, rather than relying solely on a number of reports received from the peers as was performed using conventional techniques. In this way, a single peer or even minority of peers may be prevented from bullying other peers in the network.

In another example, this score may also be calculated, at least in part, to reflect a positive score for the peer. For instance, the score may also be adjusted based on a number of peers that also received the content but did not report the content as inappropriate. A variety of other examples are also contemplated, further discussion of which may be found in relation to the following sections.

In the following discussion, an example environment is described that may employ the peer-to-peer content sharing and scoring behavior techniques described herein. Example procedures are also described which may be performed in the example environment as well as other environments. Consequently, performance of the example procedures is not limited to the example environment and the example environment is not limited to performance of the example procedures.

Example Environment

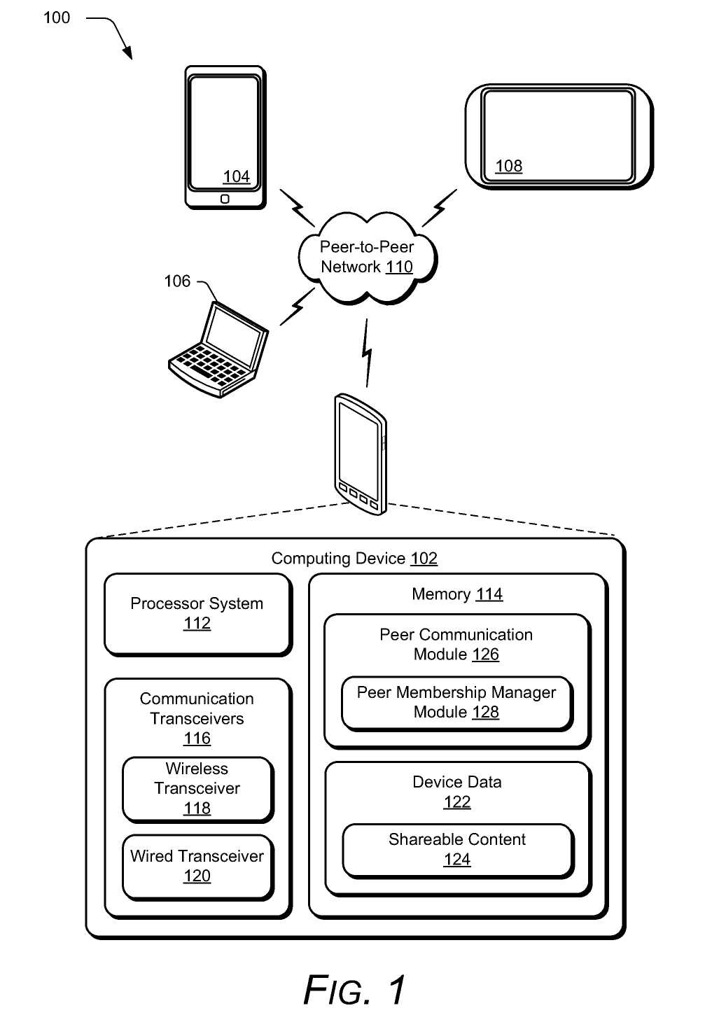

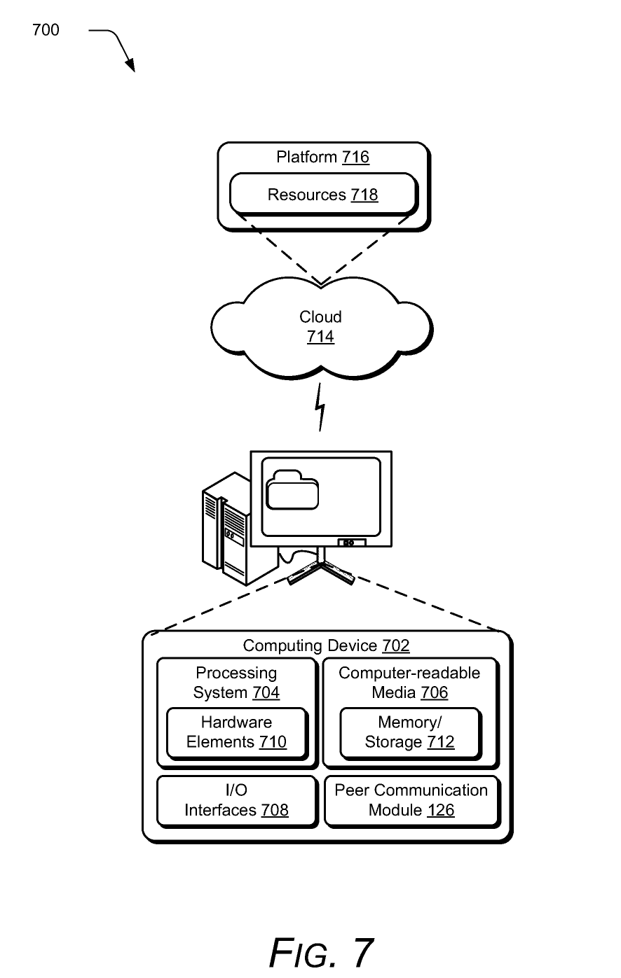

FIG. 1 is an illustration of an environment 100 in an example implementation that is operable to employ the peer-to-peer membership management techniques described herein. The environment 100 includes a computing device 102 that is communicative coupled to a plurality of other computing devices 104, 106, 108 via a peer-to-peer network 110. The computing devices 102-108 may be configured in a variety of ways. For example, a computing device 102-108 may be any type of wired or wireless electronic and/or computing device, such as a mobile phone, tablet computer, handheld navigation device, portable gaming device, media playback device, or any other type of electronic and/or computing device. Generally, any of the devices described herein can be implemented with various components, such as a processing system 112 and memory 114, as well as any number and combination of differing components as further described with reference to the example device shown in FIG. 7.

As described herein, any of the computing devices 102-108 may each be a peer device and can be connected via the peer-to-peer network 110 to other peer devices. The peer-to-peer network 110 may be implemented to include a wired and/or a wireless network. The peer-to-peer network 110 may also be implemented using any type of network topology and/or communication protocol, and can be represented or otherwise implemented as a combination of two or more networks, to include IP-based networks and/or the Internet. The peer-to-peer network 110 may also include mobile operator networks that are managed by a mobile network operator and/or other network operators, such as a communication service provider, mobile phone provider, and/or Internet service provider.

Computing device 102, for instance, may include any suitable type of communication transceivers 116, including a wireless transceiver 118 for communication via a wireless network (e.g., a mesh network) and/or a wired transceiver 120 for wired communication. The wireless transceiver 118 may be any type of transceiver configured to communicate via a wireless network, such as a wireless wide-area network (WWAN), a wireless local-area network (WLAN), and a wireless personal-area network (wireless PAN), each of which may be configured in part or entirely as infrastructure, ad-hoc, or mesh networks. For example, the wireless transceiver 118 can be implemented as a short-range wireless transceiver to communicate over a wireless personal-area-network (PAN) in accordance with a Bluetooth™ and/or Bluetooth™ low energy (BTLE) protocol. The Bluetooth™ family of protocols support various communication profiles for communicating various types of data and/or enabling different feature sets between devices connected for communication via a wireless PAN.

The Bluetooth™ and/or BTLE family of protocols also support “pairing” between devices, which may enable the computing device 102 to associate with other peer devices. When initially pairing with another device, the computing device 102 can store self-identifying information (e.g., a medium access control (MAC) address) associated with the other device in an information table (e.g., a pairing table) for future use. The information table can also store a context associated with the other device, such as an identity of a user, a mode of use for the computing device 102, and/or a location of the other device. For example, the computing device 102 may communicate with a peer device that has shareable content and is within proximity whenever the wireless transceiver 118 using Bluetooth™ is able to communicate with the paired peer device. Alternatively, the wireless transceiver may be implemented for near-field communication (NFC), to enable NFC with the peer device, in accordance with various NFC standards, such as ISO 18000-3, ISO/IEC 18092, ECMA-340, ISO/IEC 21481, and ECMA 352, just to name a few.

The computing device 102 also includes the wired transceiver 120 that may include wired data interfaces for communicating with other devices, such as an Ethernet transceiver, serial data interface, audio/video port (e.g., high-definition multimedia interface (HDMI) port), or universal serial bus (USB) port. These wired data interfaces may be implemented using standard connectors or through the use of proprietary connectors and associated cables providing enhanced security or interconnect density.

The computing device 102 as illustrated also includes device data 122 that may include shareable content 124, which is maintained in the memory 112 on the device and designated as shareable, such as by a user of the computing device. The shareable content 124 can include any content items that may be shareable between the devices, such as music, documents, emails, contacts, applications, and any other type of audio, video, and/or image data. Alternatively or in addition, the device data 122 may include other device and/or user data that is not shareable.

The computing device 102 also includes a peer communication module 126, which is illustrated as being stored in memory 114 and is executable by the processor system 112. The peer communication module 126, and its included peer membership manager module 128, may be implemented as software applications or modules (e.g., computer-executable instructions) stored on computer-readable storage memory, such as any suitable memory device or electronic data storage (e.g., the memory 112), and executed with the processing system 110.

Although shown and described as separate modules, any one or combination of the peer communication manager 126 and peer membership manager module 128 may be implemented together as a single software application or module, at least partially in hardware as further described in relation to FIG. 7. Additionally, although computing device 102 was described in detail, it should also be readily apparent that this functionality may also be incorporated by the other computing devices 104-108.

Further, in the illustrated example the peer-to-peer network 110 is managed by the peers, themselves. Other examples are also contemplated, such as to incorporate a centralized authority that includes the functionality represented by the peer membership manager module 128 but is not included as a peer within the peer-to-peer network 110.

Peer Membership Management Based on Individual Peer Reporting

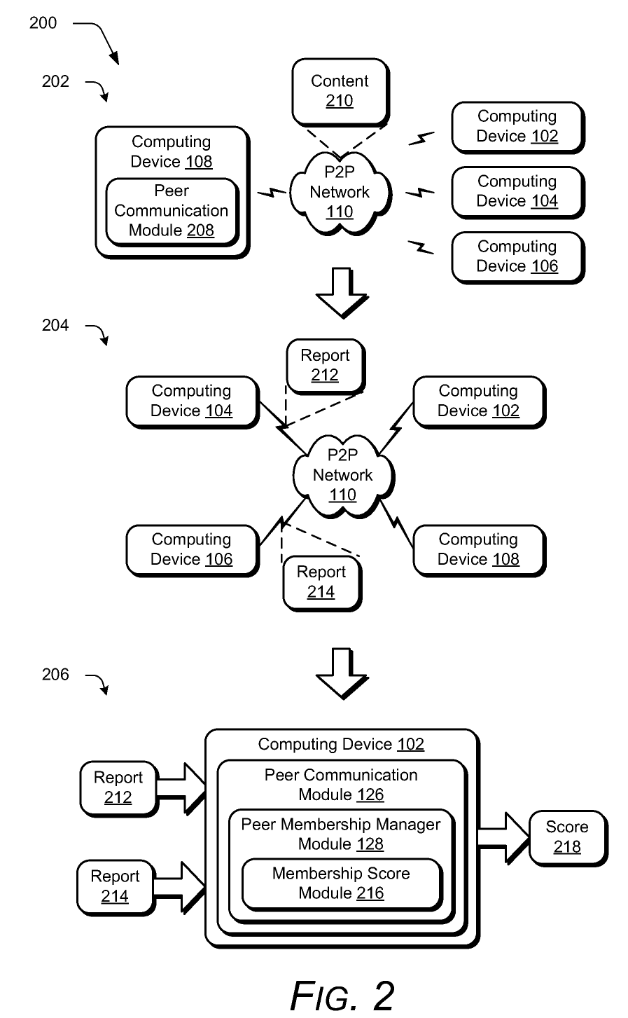

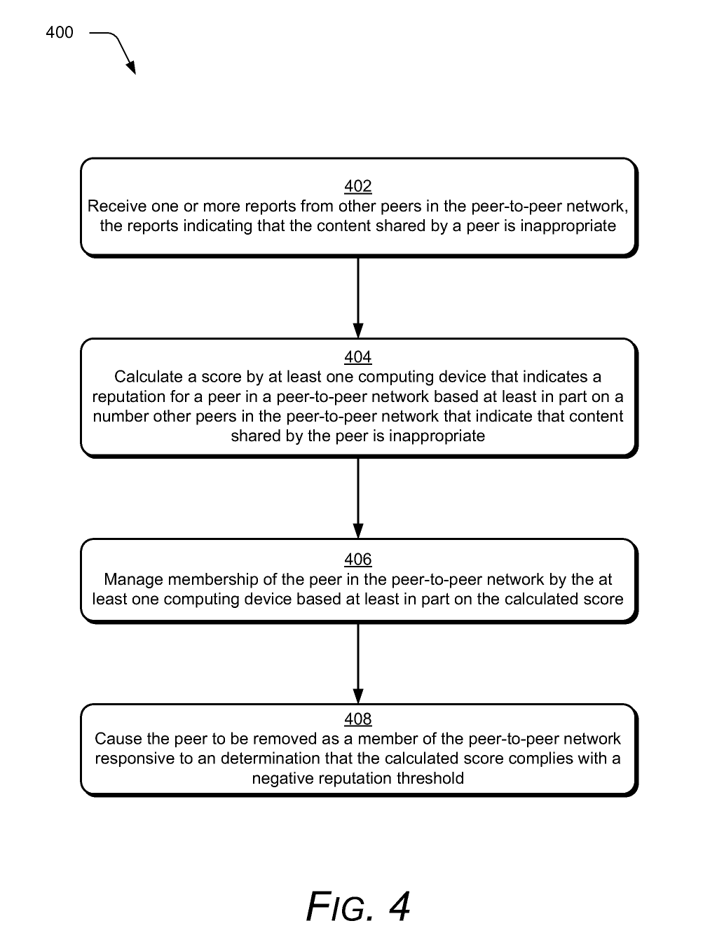

FIGS. 2-4 describe example systems 200, 300 and a procedure 400, respectively, in which peer-to-peer content sharing and scoring behaviors are described. FIG. 4 is a flow diagram that describes steps in respective procedures 400 in accordance with one or more implementations. The procedures can be performed in connection with any suitable hardware, software, firmware, or combination thereof as further described in relation to FIGS. 1 and 7. In at least some implementations, the procedure is performed, at least in part, by suitably-configured modules, such as a peer communication module 126, a peer membership manager module 128, and so on. As such, the following discussion refers to FIGS. 2-4 in the description of this example functionality.

FIG. 2 depicts a system 200 in an example implementation in which a number of peers that report content as inappropriate is utilized to calculate a score to manage membership of a peer in a peer-to-peer network. The system 200 is illustrated using first, second, and third stages 202, 204, 206. At the first stage 202, a computing device employs a peer communication module 208 to share content 210 over a peer-to-peer network 110 with other computing devices 102 104, 106 that have membership as peers in the network. A variety of different content may be shared, such as text, images, multimedia content, sound files, and so forth.

At the second stage 204, one or more reports are received from other peers in the peer-to-peer network, the reports indicating that the content shared by a peer in inappropriate (block 402 of FIG. 4). Continuing with the previous example, users of computing device 104, 106 may receive the content 210 as shown in the first stage 202, and then consider this content to be inappropriate. Content 210 may be considered inappropriate for a variety of reasons, such as due to likely copyright or trademark infringement, contain offensive material, be considered potentially harmful to children, and so on.

Accordingly, the users of computing devices 104, 106 may interact with respective peer communication modules to indicate that the received content 210 is considered inappropriate. This interaction may cause generation and communication of reports 212, 214 by respective computing devices 104, 106 for receipt by other computing devices 102, 108 via the peer-to-peer network 110. The reports 212, 214, for instance, may identify the content 210 as well as include an indication that the content 210 is considered inappropriate. The reports 212, 214 may also include an indication as to “why” the content is considered inappropriate as described above. The reports 212, 214 may be communicated to other peers that received the content 210 as well as a peer that originated the content 210, e.g., computing device 108 in this example.

At the third stage 206, a score is calculated by at least one computing device that indicates a reputation for a peer in a peer-to-peer network based at least in part on a number of other peers in the peer-to-peer network that indicate that content shared by the peer is inappropriate (block 404 of FIG. 4). Computing device 102, for instance, may receive the reports 212, 214 from computing devices 104, 106 via the peer-to-peer network 110. The reports 212, 214 may then be leveraged by a membership score module 216 of the peer membership manager module 128 to compute a score 218 that is indicative of a reputation for the peer, e.g., computing device 108, that shared the content 210 references in the reports 212, 214.

The membership score module 216, for instance, may calculate the score based at least in part on a number of peers that provided reports, i.e., a number of different, individual peers that originated the reports. Thus, the score 218 may be indicative of a number of peers that found the content inappropriate rather than solely based on a number of reports. In this way, the membership score module 216 may hinder a single peer or even a minority of the peers from blacklisting a peer by providing numerous reports, themselves, even though other peers might not find the content 210 to be inappropriate.

For example, the score 218 may be calculated, at least in part, on a percentage of peers in the peer-to-peer network that provided reports. Thus, this percentage may be set as a threshold to manage whether the peer that provided the content 210 is permitted to remain a member of the network. Further discussion of the calculation of a score may be found in the following and shown in a corresponding figure.

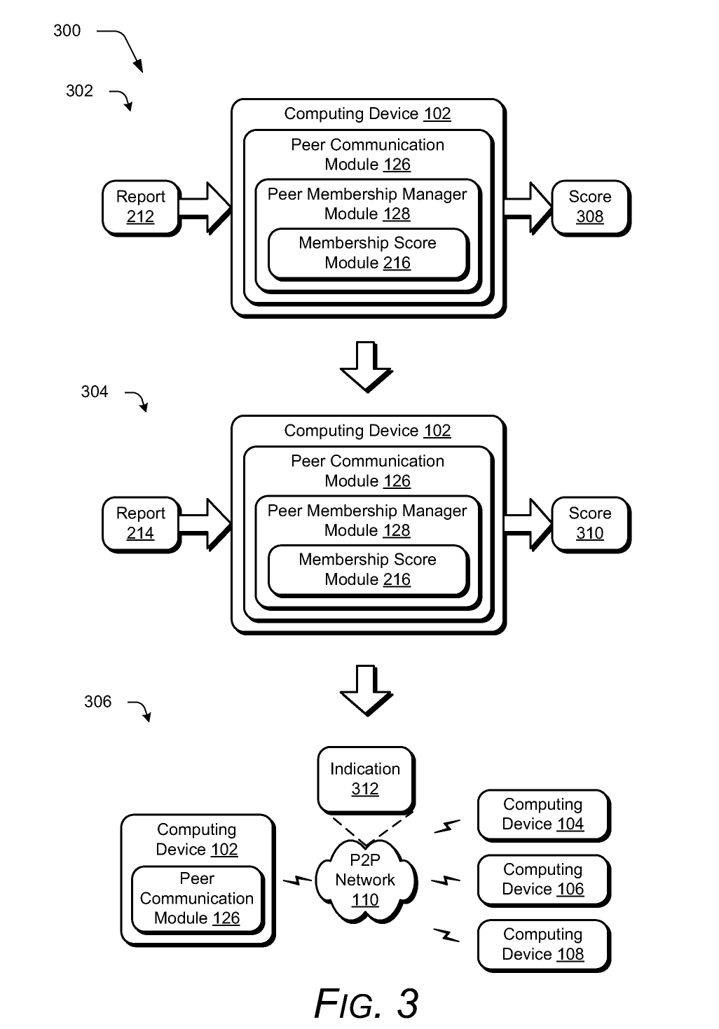

FIG. 3 depicts a system 300 in an example implementation in which a score is calculated to manage membership of a peer in a peer-to-peer network. The system 300 is illustrated using first, second, and third stages 302, 304, 306. At the first stage 302, the computing device 102 receives a report 212 from computing device 104 as described in relation to the second stage 204 of FIG. 2. In this instance, however, the score 308 is calculated upon receipt of the report 212. As this report 212 provides an indication of inappropriate content, the report is negative and has a corresponding negative effect on the score 308 and corresponding reputation of the peer. Thus, although a “negative” effect is described it should be readily apparent that this effect is not limited to reduction of a numerical value.

The negative effect on the score may be calculated in a variety of ways. For example, a new score may be calculated from a current score from which a result of a base score for an inappropriate content report is divided by a count indicating a number of reports received from a same peer. In this way, a negative effect of successive reports from a same user may be lessened, without reducing an effect of another report 214 received from another computing device 106 on calculation of a subsequent score 310 as shown in the second stage 304.

Thus, the membership score module 216 may be configured to reduce a likelihood and even prevent a single peer or minority of peers from blacklisting or bullying other peers in the peer-to-peer network 110 yet still support a large diverse groups of peers the ability to blacklist another peer, in comparison with a small group of users blacklisting a large number of content for a peer.

Thus, membership of the peer in the peer-to-peer network may be managed by at least one computing device based at least in part on the calculated score (block 406 of FIG. 4). A negative reputation threshold, for instance, may be employed by the peer membership manager module 128 such that, when the score 310 complies with this threshold, the peer is caused to be removed as a member of the peer-to-peer network (block 408 of FIG. 4).

As illustrated in the third stage 306, for instance, the peer communication module 126 may communicate an indication 312 for receipt by other computing devices 104, 106, 108, including the computing device 108 that originated the content 210 that was indicated as inappropriate. This indication 312 may cause the peers remaining in the peer-to-peer network 110 from accepting communications from computing device 108, which is now “blacklisted.” Mechanisms may also be supported for the computing device 108 to appeal this removal, such as to support limited communication with the other peers.

In this example, a number of individual peers is leveraged to compute a score usable to help in management of membership of peers in a peer-to-peer network. This management may also be configured to leverage positive indications of a likely appropriateness of the content 210, further discussion of which may be found in the following and shown in corresponding figures.

Peer Membership Management and Positive Indications

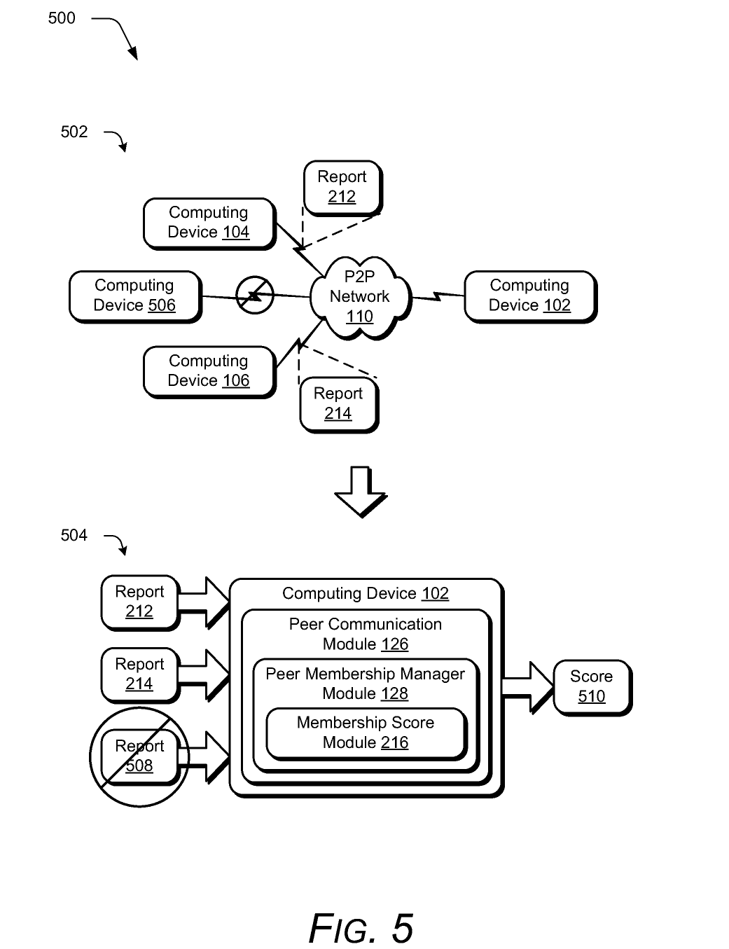

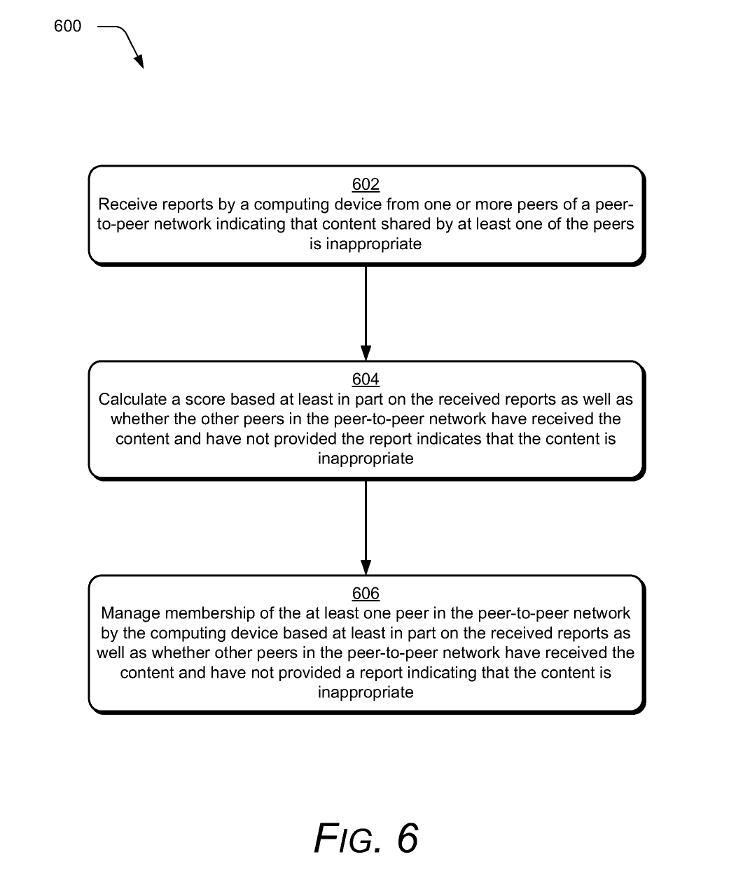

FIGS. 5-6 describe an example system 500 and a procedure 600, respectively, in which scoring behaviors that include use of likely positive indications are described. FIG. 6 is a flow diagram that describes steps in respective procedures 600 in accordance with one or more implementations. The procedures can be performed in connection with any suitable hardware, software, firmware, or combination thereof as further described in relation to FIGS. 1 and 7. In at least some implementations, the procedure is performed, at least in part, by suitably-configured modules, such as a peer communication module 126, a peer membership manager module 128, and so on. As such, the following discussion refers to FIGS. 5-6 in the description of this example functionality.

FIG. 5 depicts a system 500 in an example implementation in which reports of content as inappropriate is utilized along with a lack of such reports to calculate a score to manage membership of a peer in a peer-to-peer network. The system 500 is illustrated using first and second stages 502, 504. At the first stage 502, computing devices 104, 106 each provide reports 212, 214 as previously described that indicate that content 110 received from computing device 108 is deemed inappropriate. However, in this case computing device 506, which is also a peer in the peer-to-peer network 110, has also received the content 110 but has not provided a report indicating that the content is inappropriate.

Consequently, at the second stage 504 reports are received by the computing device 102 from one or more peers of a peer-to-peer network indicating that content shared by at least one of the peers is inappropriate (block 602 of FIG. 6). A score is calculated based at least in part on the received reports as well as whether the other peers in the peer-to-peer network have received the content and have not provided the report that indicates that the content is inappropriate (block 604 of FIG. 6).

As shown in the second stage 504 and continuing with the previous example, reports 212, 214 are received from computing devices 104, 106. However, a report 508 is not received from computing device 506, which also received the content 210. For example, a threshold amount of time may be employed such that, if the report is not received within that amount of time an assumption is made that the peer did not deem the content as inappropriate. Thus, this lack of sending a report may be taken as an indication of a likely positive experience with the content 110 by a user of the computing device 506.

This indication/assumption may then be utilized as part of the calculation of a score 510 indicative of a reputation associated with the computing device 108 that provided the content 110. For example, a new score may be computed as a sum of a current score, to which, a base download score is added for each computing device that received the content 110 but did not report it as inappropriate. In this way, membership of the at least one peer in the peer-to-peer network is managed by the computing device based at least in part on the received reports as well as whether other peers in the peer-to-peer network have received the content and have not provided a report indicating that the content is inappropriate (block 606 of FIG. 6). It should be readily apparent that this technique may be combined with the previous techniques involving a number of peers without departing from the spirit and scope thereof.

Example System and Device

FIG. 7 illustrates an example system generally at 700 that includes an example computing device 702 that is representative of one or more computing systems and/or devices that may implement the various techniques described herein, e.g., may operate as a “peer” within the environment 100 of FIG. 1. This is illustrated through inclusion of the peer communication module 126. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
calculating a score, by at least one computing device, that indicates a reputation for a peer in a peer-to-peer network based at least in part on a number other peers in the peer-to-peer network that indicate that content shared by the peer is inappropriate; and
managing membership of the peer in the peer-to-peer network by the at least one computing device based at least in part on the calculated score.

2. A method as described in claim 1, wherein the calculating is performed such that an effect on the score of successive reports from a same said other peer is reduced.

3. A method as described in claim 1, wherein the calculating of the score is based at least in part on a current score from which is subtracted a result of a base score for inappropriate content divided by a number of reports that indicate that the content shared by the peer is inappropriate that originate from an individual ones of the other peers.

4. A method as described in claim 1, wherein the calculating of the score is also based at least in part on a number of the other peers in the peer-to-peer network that have not provided one of the reports that indicate that the content is inappropriate.

5. A method as described in claim 4, wherein the score, as calculated of based at least in part on the number of the other peers in the peer-to-peer network that have not provided one of the reports, causes the managing to be performed such that the peer is less likely to be removed as a member of the peer-to-peer network.

6. A method as described in claim 4, wherein the score is calculated as a current score to which a base download score is added for each of the number of the other peers in the peer-to-peer network that have received the content and have not provided one of the reports.

7. A method as described in claim 1, wherein the at least one computing device that performs the managing is included as one of the peers in the peer-to-peer network.

8. A method as described in claim 1, wherein the at least one computing device that performs the managing is a centralized authority of the peer-to-peer network and is not one of the peers in the peer-to-peer network.

9. A method as described in claim 1, further comprising receiving one or more reports from the other peers in the peer-to-peer network, the reports indicating that the content shared by the peer is inappropriate.

10. A method as described in claim 1, further comprising causing the peer to be removed as a member of the peer-to-peer network responsive to a determination that the calculated score corresponds to a negative reputation threshold.

11. A method comprising:
receiving reports by a computing device from one or more peers of a peer-to-peer network indicating that content shared by at least one of the peers is inappropriate; and
managing membership of the at least one peer in the peer-to-peer network by the computing device based at least in part on the received reports as well as whether other peers in the peer-to-peer network have received the content and have not provided a report indicating that the content is inappropriate.

12. A method as described in claim 11, further comprising calculating a score based at least in part on the received reports as well as whether the other peers in the peer-to-peer network have received the content and have not provided the report indicates that the content is inappropriate and wherein the managing is performed based at least in part on the score.

13. A method as described in claim 12, wherein the calculating of the score is based at least in part on a current score from which is subtracted a result of a base score for inappropriate content divided by a number of reports that indicate that the content shared by the peer is inappropriate that originate from an individual ones of the other peers.

14. A method as described in claim 12, wherein the score is calculated as a current score to which a base download score is added for each of the number of the other peers in the peer-to-peer network that have not provided one of the reports.

15. A method as described in claim 11, wherein the managing is performed such that single one of the peers is not permitted to cause the at least one peer to be removed from the peer-to-peer network.

16. A system comprising:
one or more modules implemented at least partially in hardware, the one or more modules configured to perform operations comprising:
receiving one or more reports that content shared by a peer is inappropriate;
calculating a score that indicates a reputation for the peer in a peer-to-peer network based at least in part on a number other peers in the peer-to-peer network that indicate that the content shared by the peer is inappropriate; and
managing membership of the peer in the peer-to-peer network based at least in part on the calculated score.

17. A system as described in claim 16, wherein the calculating of the score is based at least in part on a current score from which is subtracted a result of a base score for inappropriate content divided by a number of reports that indicate that the content shared by the peer is inappropriate that originate from an individual ones of the other peers.

18. A system as described in claim 16, wherein the calculating of the score is also based at least in part on a number of the other peers in the peer-to-peer network that have not provided one of the reports that indicate that the content is inappropriate.

19. A system as described in claim 18, wherein the score, as calculated of based at least in part on the number of the other peers in the peer-to-peer network that have not provided one of the reports, causes the managing to be performed such that the peer is less likely to be removed as a member of the peer-to-peer network.

20. A system as described in claim 18, wherein the score is calculated as a current score to which a base download score is added for each of the number of the other peers in the peer-to-peer network that have received the content and have not provided one of the reports.
